(19) United States
(12) Patent Application Publication
(10) Pub. No.: US 2010/0176678 A1
(43) Pub. Date: Jul. 15, 2010

(54) ELECTRIC MOTOR

(76) Inventors: James Ching Sik LAU, Hong Kong (CN); Duncan Yiu Lung Wong, Hong Kong (CN); Yuen Tung Louie, Hong Kong (CN)

Correspondence Address: Muncy, Geissler, Olds & Lowe, PLLC, 4000 Legato Road, Suite 310, FAIRFAX, VA, 22033, US

(21) Appl. No.: 12/684,417

(22) Filed: Jan. 8, 2010

(30) Foreign Application Priority Data
Jan. 9, 2009 (CN) 200910104866.6

(51) Int. Cl. H02K 1/28

(52) U.S. Cl. 310/156.16

(57) ABSTRACT

An electric motor includes a stator and a rotor. The stator has a housing and a single ceramic permanent magnet disposed in the housing. The magnet has a C-shaped cross section. During assembly the magnet is resiliently deformed to allow the magnet to be inserted into the housing. The inner diameter of the housing is less than the outer diameter of the magnet in its relaxed state such that once inserted in the housing the magnet is kept resiliently deformed by the housing. The magnet thus generates a radial force acting on the inner surface of the housing which results in the magnet being firmly retained in the housing. A slot is formed between opposing circumferential ends of the magnet. The slot extends from one axial end of the magnet to the other axial end. Preferably, a spacer is pressed into the slot and an interlock structure is arranged between the spacer and the housing to prevent the magnet from moving relative to the housing.

### CROSS REFERENCE TO RELATED APPLICATIONS

This non-provisional patent application claims priority under 35 U.S.C. §119(a) from Patent Application No. 200910104866.6 filed in The People's Republic of China on Jan. 9, 2009.

### FIELD OF THE INVENTION

This invention relates to an electric motor and in particular, to an electric motor having a permanent magnet stator and especially to a PMDC micro motor.

### BACKGROUND OF THE INVENTION

An inner-rotor permanent magnet direct current (PMDC) motor has a permanent magnet stator and a rotor disposed in the stator. The stator comprises a housing and a plurality of individual magnets attached to the inner surface of the housing by adhesive, magnet holders or other means.

However, it is difficult to keep the plurality of individual magnets coaxial to each other during assembly. Furthermore, it is time-consuming to attach multiple magnets to the housing. The more magnets there are, the greater the difficulty and thus time required to assemble.

Ceramic ring magnets have been used in PMDC motors but due to the brittle nature of the ceramic magnets, there is a gap between the housing and the magnet to allow for assembly and for the adhesive to hold the magnet to the housing. This gap reduces the efficiency of the stator. The use of adhesive slows down the assembly process due to the time needed for the adhesive to set, during which the stator should not be moved. Bonded or rubber ring magnets are also known and are produced by rolling a strip of rubber magnet and placing it in the housing. However, while rubber magnets are flexible and not brittle like ceramic magnets they do have a much lower power density and thus are only suitable for low power density motors. However, as space is a premium, most applications require increased power from smaller motors.

By ceramic magnet, we mean that the magnet is of a hard, dense and brittle nature, generally made by a sintering or similar process. Although of a brittle nature, the ceramic magnets can be resiliently deformed within limits.

### SUMMARY OF THE INVENTION

Hence there is a desire for an improved ceramic permanent magnet stator for an electric motor which overcomes the above-mentioned problem.

This is achieved in the present invention by using a magnet with a C-shaped cross section and resiliently deforming the magnet to urge the magnet into contact with the housing.

Accordingly, in one aspect thereof, the present invention provides an electric motor having a stator and a rotor, the stator comprising a housing and a single ceramic permanent magnet disposed within the housing, wherein the magnet has a C-shaped cross section with a slot formed between circumferentially opposing ends of the magnet, the slot extending from one axial end of the magnet to the other axial end and the magnet is resiliently deformed to generate a radial force against an inner surface of the housing to retained the magnet within the housing.

Preferably, the housing and the magnet each have a cylindrical configuration, and the inner diameter of the housing is slightly less than the outer diameter of the magnet in the relaxed state.

Preferably, the slot is parallel to the axis of the stator.

Preferably, the slot has a non-uniform width.

Preferably, a spacer is disposed in the slot to resiliently urge the magnet into contact with the housing.

Preferably, an interlock structure is arranged between the spacer and the housing to prevent the magnet from moving circumferentially with respect to the housing.

Preferably, the interlock structure comprises a recess formed in one of the spacer and the housing, and a protrusion formed on the other of the spacer and the housing and engaged with the recess.

Preferably, the spacer has a trapezoid-shaped cross section with the long edge of the trapezoid-shaped cross section is adjacent the inner surface of the housing.

Alternatively, the spacer has a fusiform-shaped or U-shaped cross section.

Preferably, the housing has inner threads formed on an inner surface thereof and the magnet has outer threads formed on an outer surface thereof, the outer threads being engaged with the inner threads.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labelled with a same reference numeral in all the figures in which they appear. Dimensions of components and features shown in the figures are generally chosen for convenience and clarity of presentation and are not necessarily shown to scale. The figures are listed below.

FIG. 1 is a partially exploded isometric view of a stator of an electric motor according to a preferred embodiment of the present invention;

FIG. 2 is an isometric view of a magnet of the stator of FIG. 1;

FIG. 3 is a cross sectional view of the stator of FIG. 1;

FIG. 4 is an end view of the magnet of FIG. 2;

FIGS. 5 to 7 show isometric views of magnets with a variety of slot shapes;

FIG. 8 is a partially exploded isometric view of a stator of an electric motor according to a second embodiment of the present invention;

FIG. 9 is a cross sectional view of the stator of FIG. 8;

FIG. 10 is a longitudinal sectional view of the stator of FIG. 8;

FIG. 11 is an enlarged view of the encircled portion of FIG. 10;

FIG. 12 is a partially exploded isometric view of a stator of an electric motor according to a third embodiment of the present invention;

FIG. 13 is a cross sectional view of the stator of FIG. 12;

FIG. 14 is a partially exploded isometric view of a stator of an electric motor according to a fourth embodiment of the present invention;

FIG. 15 is a cross sectional view of the stator of FIG. 14;

FIG. 16 is a partially exploded isometric view of a stator of an electric motor according to a fifth embodiment of the present invention;

FIG. 17 is a cross sectional view of the stator of FIG. 16;

FIG. 18 is a partially exploded, partially sectioned, isometric view of a stator of an electric motor according to a sixth embodiment of the present invention; and

FIG. 19 depicts an electric motor to which the present invention may be applied.

### DETAILED DESCRIPTION OF THE PREFERRED EMBODIMENTS

FIG. 19 illustrates a typical PMDC motor 12 to which the present invention may be applied. The motor has a permanent magnet stator comprising a permanent magnet fitted to a housing 20. The magnet is a single piece ceramic or sintered magnet. It may be of rare earth or a more common composition. The housing 20 is of the deep drawn variety with an open end which is closed by an end cap 14 which supports motor terminals 15 and brush gear (not shown). The housing accommodates a wound rotor, including a motor shaft 13 which extends through the end cap 14.

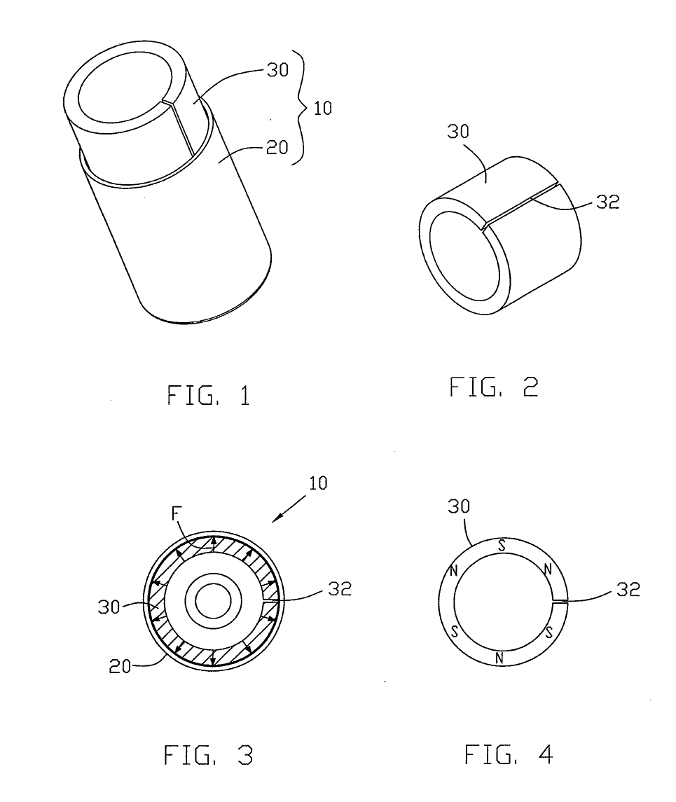

FIG. 1 illustrates a stator 10 of an electric motor, according to a first preferred embodiment. The stator 10 comprises a housing 20 and a single piece magnet 30 disposed within the housing 20. The stator is shown partially exploded to show the shape of the magnet. In the fully assembled position the magnet is completely inserted into the housing and the housing provides the primary flux return path for the magnet.

In this embodiment, the housing 20 has a cylindrical configuration. As shown in FIG. 2, the magnet 30 also has a substantially cylindrical configuration with a C-shaped cross section. In practice, the C-shaped magnet would be formed by cutting a ring magnet. Thus a slot 32 is formed between two circumferentially facing ends of the magnet 30 and extends from one axial end to the other axial end of the magnet 30. Before assembly, the outer diameter of the magnet 30, in its relaxed state, is slightly greater than the inner diameter of the housing 20. During assembly, the magnet 30 is squeezed and resiliently deformed to thereby reduce its outer diameter such that the magnet 30 can be inserted into the housing 20. This resilient deformation reduces the width of the slot 32. After the magnet 30 has been inserted into the housing 20, the magnet 30 is released. As the magnet 30 tries to return to its original shape, but can not due to the restriction placed on it by the housing, it generates a restoring force F due to the resilient deformation, as shown in FIG. 3. The force F acts radially on the inner surface of the housing 20. Thus, the magnet 30 is firmly retained in the housing 20.

As shown in FIG. 4, the magnet 30 may be polarized or charged to have a plurality of poles, such as 2 poles, 4 poles, 6 poles, 8 poles, etc.

Preferably, the slot 32 is parallel to the axis of the housing 20, for easy of manufacturing. Alternatively, the slot 32 may be slanted or skewed relative to the axis of the housing 20, as shown in FIG. 5.

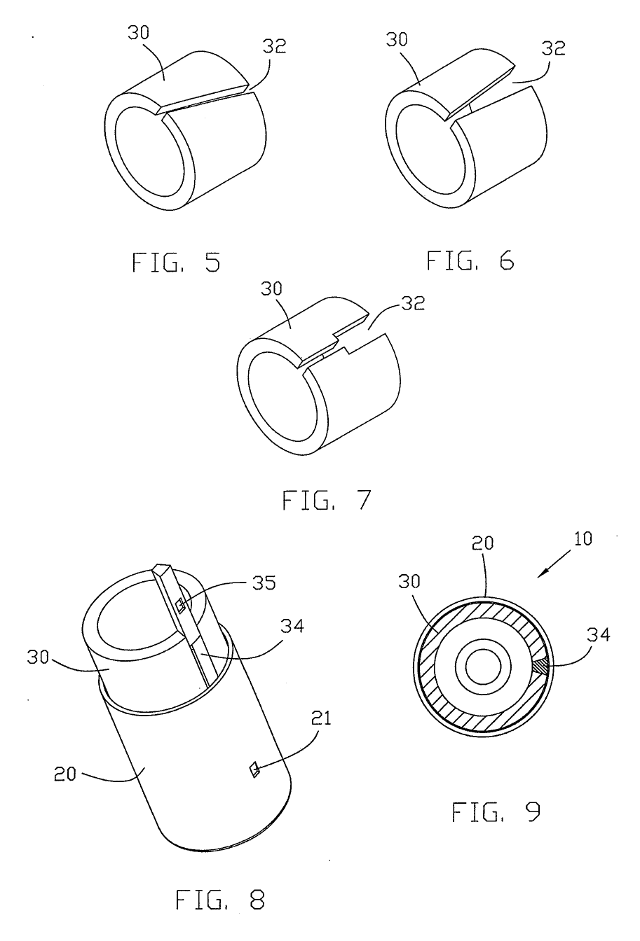

Preferably, the slot 32 has a uniform width, again for ease of manufacture. Alternatively, the slot 32 may have a non-uniform width, for example, the width of the slot 32 gradually increases from one end to the other end, as shown in FIG. 6, or the slot 32 comprises two sections each having a uniform width with one section thereof being narrower than the other section, as shown in FIG. 7.

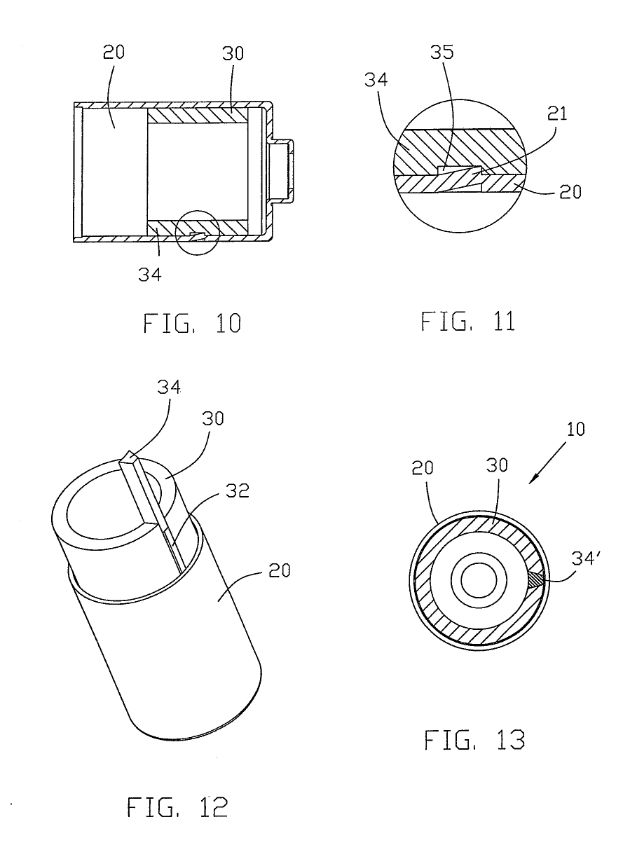

A second preferred embodiment is shown in FIGS. 8 to 11. In this embodiment, a spacer 34 is inserted into the slot 32 and sandwiched between the two facing circumferential ends of the magnet 30. The outer diameter of the magnet 30 may be slightly greater than, slightly less than or equal to the inner diameter of the housing 20. During assembly, the magnet 30 is inserted into the housing 20. If the outer diameter of the magnet is equal to or greater than the inner diameter of the housing, the magnet 30 is squeezed to be resiliently deformed to thereby reduce its outer diameter such that it can be more easily inserted into the housing. After the magnet 30 is inserted into the housing 20, the spacer 34 is pressed into the slot 32 such that circumferentially facing ends of the magnet 30 are urged apart. If the relaxed outer diameter of the magnet was equal to or less than the inner diameter of the housing, the magnet is resiliently deformed to generate a radial force acting on the inner surface of the housing 20. If the magnet 30 was larger than the housing then the spacer 34 assists the resilient restoring force of the magnet and increases the radial force applied by the magnet to the housing. Thus, the magnet 30 with the spacer 34 is securely retained in the housing 20.

Preferably, an interlock structure is arranged between the spacer 34 and the inner surface of the housing 20 to prevent the magnet 30 from moving relative to the housing 20. The interlock structure may comprises a recess formed at one of the spacer 34 and the housing 20, and a protrusion formed at the other of the spacer 34 and the housing 20 and engaged in the recess. In this embodiment, a recess 35 is formed in the radially outer surface of the spacer 34, and a protrusion 21 is formed on the inner surface of the housing 20 and engages the recess 35.

The shape of the spacer may be chosen for convenience but a spacer with a trapezoid-shaped cross section having a short edge and a long edge opposing the short edge with the short edge closer to the center of the stator, as shown in FIG. 9, is particularly preferred. This arrangement is self supporting in that the spacer is wedged between the magnet and the housing and can not move or become dislodged in a direction radially of the stator. The spacer is also prevented from moving in the axial direction by the interlock structure and thus does not require additional parts to hold it in place.

Alternatively, the short edge of the trapezoid-shaped cross section of the spacer 35 may face away from the center of the stator, as shown in FIGS. 12 and 13. However, as mention about, this arrangement is not self supporting.

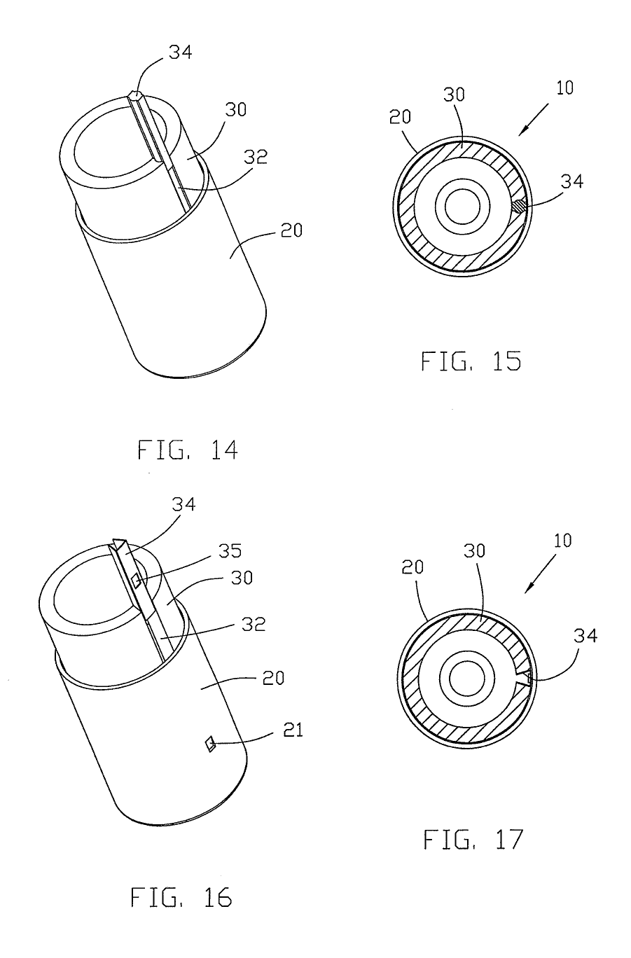

Alternatively, as shown in FIGS. 14 and 15, the cross section of the spacer 35 may be fusiform-shaped and the middle part is wider than opposite ends in the radial direction. In this manner, the spacer can be self supporting also, if the facing ends of the magnet are similarly shaped.

In an alternative embodiment, as shown in FIGS. 16 and 17, the cross section of the spacer 34 is U-shaped with the open end facing the center of the stator. The base portion of the U is then adjacent the housing and the interlock structure as described about comprises a recess 35 in the base portion of the spacer 34 and the protrusion 21 formed on the inner surface of the housing 20. The protrusion 21 is most conveniently formed by stamping or pressing the outer surface of the housing.

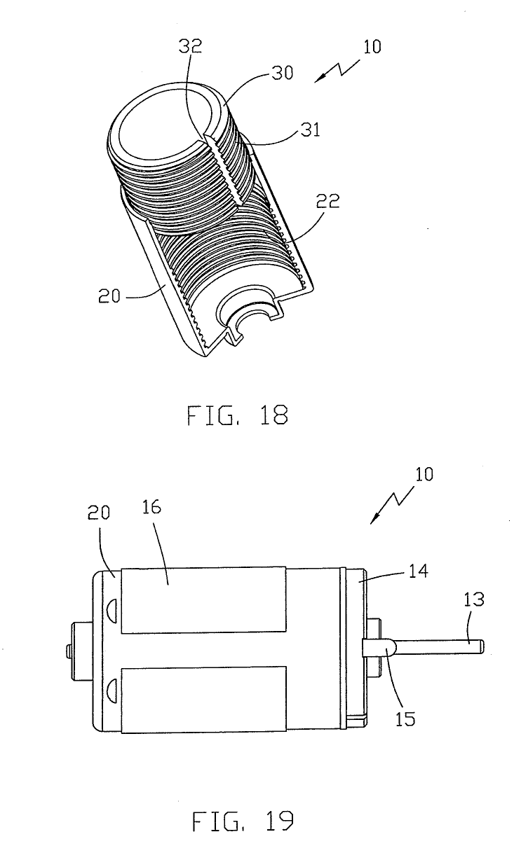

FIG. 18 shows a partially exploded stator in accordance with an alternative embodiment of the present invention. The housing 20 has inner threads 22 formed on the inner surface thereof and the magnet 30 has outer threads 31 formed on the outer surface thereof. The outer threads 31 engage with the inner threads 22 to assist holding of the magnet and allow the magnet to be fitted to the housing by being screwed into the housing. In this embodiment, it is preferred that the outer diameter of the magnet is slightly greater than the inner diameter of the housing so as to resiliently deform the magnet as it is screwed into the housing.

Alternatively, a spacer is pressed into the slot to resiliently urge the magnet into contact with the housing. This is similar to the arrangement of the embodiment of FIG. 8 or FIG. 14 and is particularly useful where the outer diameter of the magnet in the relaxed state is less than the inner diameter of the housing.

The above embodiments illustrate the usefulness of this invention by providing a simple yet effective arrangement to fit a ceramic or sintered single piece permanent magnet to a housing to form the permanent magnet stator of a PMDC motor. It is particularly useful for small size motors such as miniature motors and micro motors in the less than 100 watts range.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. An electric motor having a stator and a rotor, the stator comprising a housing and a single ceramic permanent magnet disposed within the housing, wherein the magnet has a C-shaped cross section and is resiliently deformed to generate a radial force against an inner surface of the housing to retained the magnet within the housing.

2. The motor of claim 1, wherein a slot is formed between opposing circumferential ends of the magnet, the slot extending from one axial end of the magnet to the other axial end of the magnet.

3. The motor of claim 2, wherein the housing and the magnet each have a cylindrical configuration, and the outer diameter of the housing is slightly less than the inner diameter of the magnet.

4. The motor of claim 2, wherein the slot is parallel to the axis of the stator.

5. The motor of claim 2, wherein the slot has non-uniform width.

6. The motor of claim 2, wherein a spacer is disposed in the slot to resiliently urge the magnet into contact with the housing.

7. The motor of claim 6, wherein an interlock structure is arranged between the spacer and the housing to prevent the magnet from moving circumferentially with respect to the housing.

8. The motor of claim 7, wherein the interlock structure comprises a recess formed in one of the spacer and the housing, and a protrusion formed on the other of the spacer and the housing and engaged with the recess.

9. The motor of claim 6, wherein the spacer has a trapezoid-shaped cross section with the long edge of the trapezoid-shaped cross section is adjacent the inner surface of the housing.

10. The motor of claim 6, wherein the spacer has a fusiform-shaped cross section.

11. The motor of claim 6, wherein the spacer has a U-shaped cross section.

12. The motor of claim 1, wherein the housing has inner threads formed on an inner surface thereof and the magnet has outer threads formed on an outer surface thereof, the outer threads being engaged with the inner threads.

13. An electric motor having a stator and a rotor, the stator comprising a housing and a single ceramic magnet disposed within the housing, wherein the magnet has a C-shaped cross section, the housing has inner threads formed on an inner surface thereof, the magnet has outer threads formed on an outer surface thereof, the outer threads being engaged with the inner threads.

14. The motor of claim 13, wherein the magnet, before being installed in the housing, has an outer diameter slightly greater than or equal to the inner diameter of the housing.

15. The motor of claim 13, wherein a slot is formed between circumferentially opposing ends of the magnet, the slot extending from one axial end of the magnet to the other axial end of the magnet and a spacer is pressed into the slot to resiliently urge the magnet into contact with the housing.
